(19) United States
(12) Patent Application Publication
(10) Pub. No.: US 2019/0285966 A1
(43) Pub. Date: Sep. 19, 2019

(54) Fiber-optic connected logic (FOCL)

(71) Applicant: Kay C. Robinson, JR., Detroit, MI (US)

(72) Inventor: Kay C. Robinson, JR., Detroit, MI (US)

(21) Appl. No.: 15/932,565

(22) Filed: Mar. 13, 2018

(51) Int. Cl. G02F 3/00

(52) U.S. Cl. CPC G02F 3/00; G02F 2201/02

(57) ABSTRACT

Within the integrated circuit there are a significant number of components and not all of them are electronic switches. In an effort to increase data speeds, lower power consumption, increase the functions within the integrated circuit, simplify circuits, and increase the overall processing power of the circuit chip the use fiber-optic transmission lines between transistors instead of metallic conductor should be used within the circuit chip. This would be used purely for the transmission of data and communication. With fiber-optic transmission lines, microscopic LED's and photodiode's the electronic/electrical design of logic gates would become simpler, there would be faster data transmission, less corrupted data, and a longer lifespan for the semiconductor circuit chips that are data processers.

### BACKGROUND OF THE INVENTION

The present invention is an electronic circuit design method that incorporates fiber optic lines between individual logic gates for transmitting data. Using fiber optics as data transmission between logic circuits would make a simplified logic circuit construction best. Although the design of any logic circuit does not necessarily have to follow this or any suggested design the use of fiber optics for transmitting data between the logic gates is the core of this design method. What's important is the function of the desired circuit. For this reason, schematic symbols are used in electrical, electronic, and computer engineering to represent small complete circuits that have known function. As long as the design proves the truth table, that is associated with that particular logic circuit, correct then the circuit works.

### SUMMARY OF THE INVENTION

Each transistor and diode has what is called a propagation delay. This is the amount of time the transistor or diode takes to go from on to off and vice versa. Realizing this the more electronic switches used in a particular device the slower the circuit will be in performing the appropriate function. Using fiber optics to transmit data between logic gates increases the speeds and provides other benefits as well such as lower power consumption and lower possibility of faulty information being transmitted and received. This invention is primarily intended for data transmission and not for power amplification, transformation, or the increasing or decreasing of voltage.

### BRIEF DESCRIPTION OF THE DRAWINGS

FIG. 1 illustrate the schematic symbol for the inverter or NOT gate circuit.

FIG. 1a illustrates the truth table for the inverter circuit.

FIG. 1b illustrates the inverter circuit using a single BJT transistor.

FIG. 1c illustrates the inverter circuit using a single FET transistor.

FIG. 2 illustrates the schematic symbol for the AND gate circuit.

FIG. 2a illustrates the truth table for the AND gate circuit.

FIG. 2b illustrates the AND gate circuit using two BJT transistors connected in series.

FIG. 2c illustrates the AND gate circuit using two FET transistors connected in parallel.

FIG. 3 illustrates the schematic symbol for the OR gate circuit.

FIG. 3a illustrates the truth table for the OR gate circuit.

FIG. 3b illustrates the OR gate circuit using two BJT transistors connected in parallel.

FIG. 3c illustrates the OR gate circuit using two FET transistors connected in parallel.

FIG. 4 illustrates the schematic symbol for the NAND gate circuit.

FIG. 4a illustrates the truth table for the NAND gate circuit.

FIG. 4b illustrates the NAND gate circuit using two BJT transistors connected in series.

FIG. 4c illustrates the NAND gate circuit using two FET transistors connected in parallel.

FIG. 5 illustrates the schematic symbol for the NOR gate circuit.

FIG. 5a illustrates the truth table for the NOR gate circuit.

FIG. 5b illustrates the NOR gate circuit using two BJT transistors connected in parallel.

FIG. 5c illustrates the NOR gate circuit using two FET transistors connected in parallel.

FIG. 6 illustrates a design using the schematic symbols for the logic gate circuits.

FIG. 6a illustrates a detailed schematic of how the logic gates would connect to each other using BJT transistors.

FIG. 6b illustrates a detailed schematic of how the logic gates would connect to each other using FET transistors.

### DETAILED DESCRIPTION

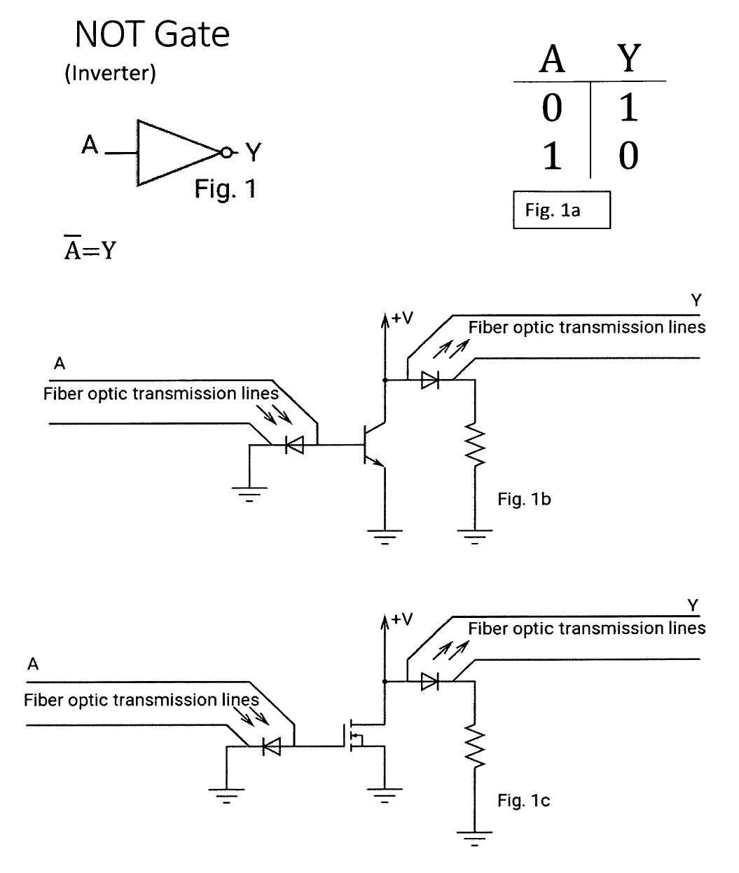

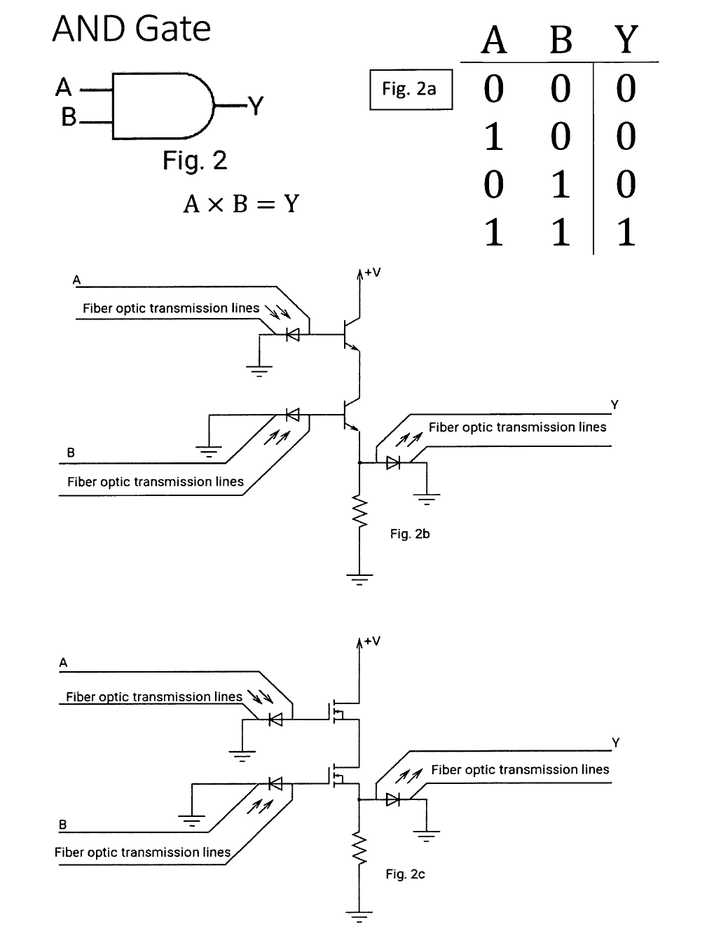

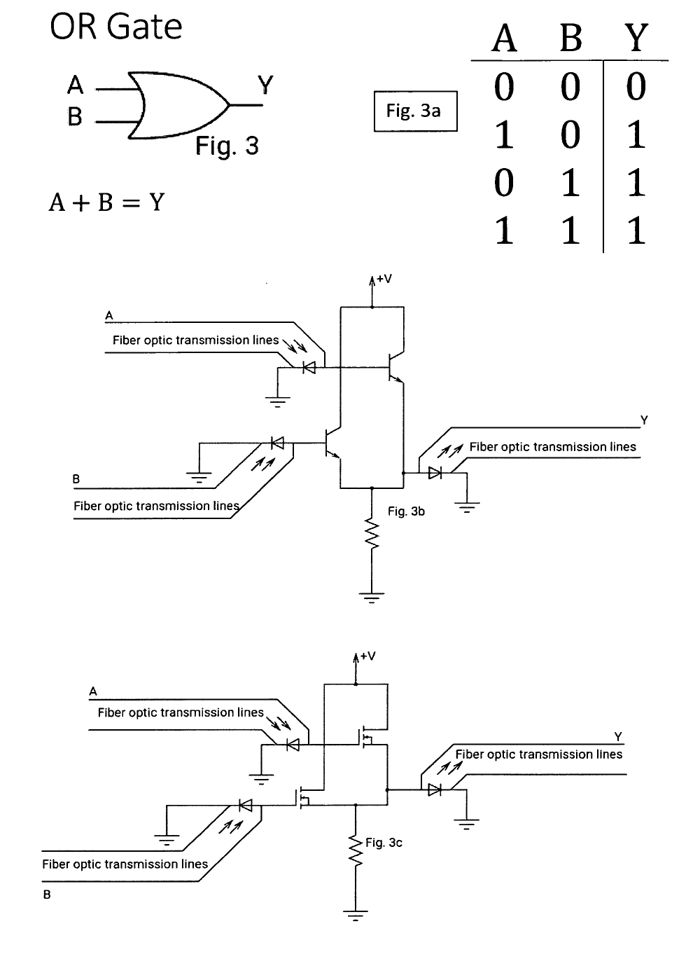

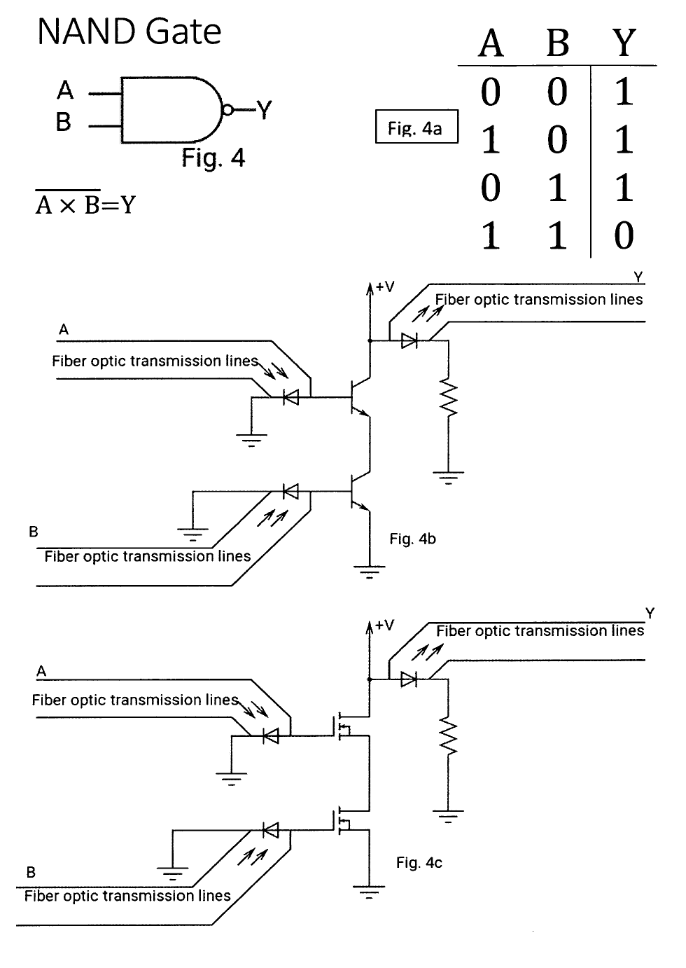

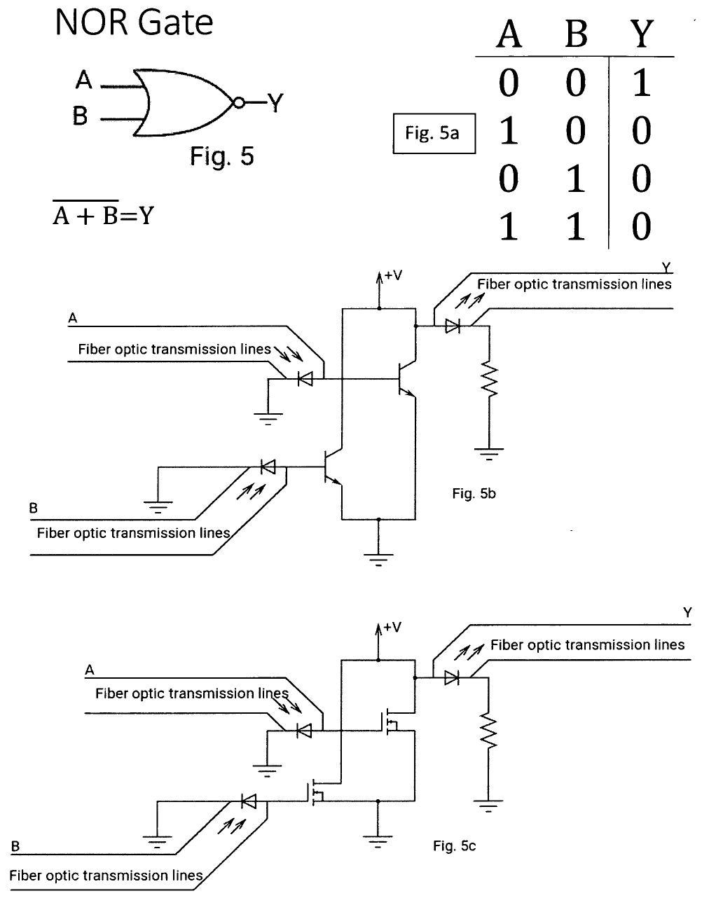

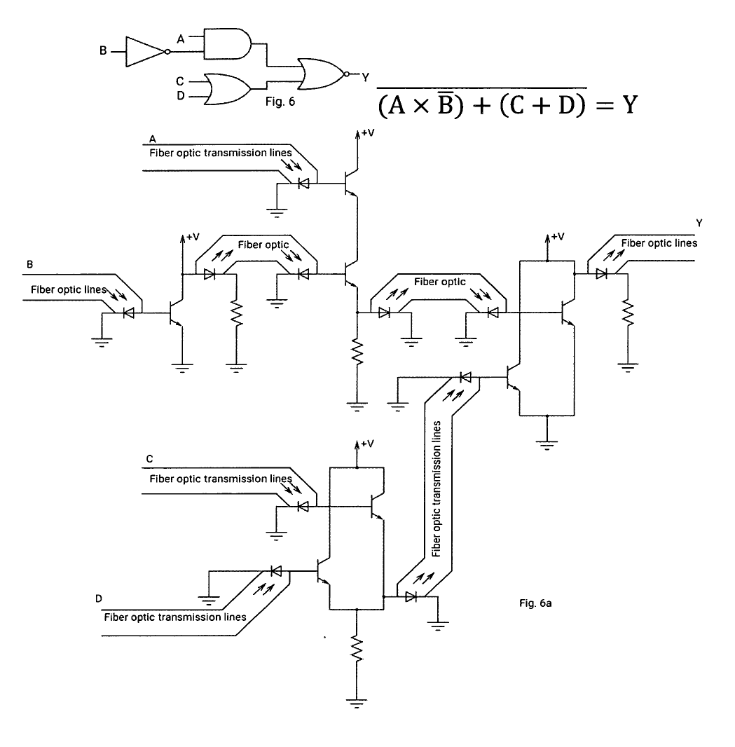

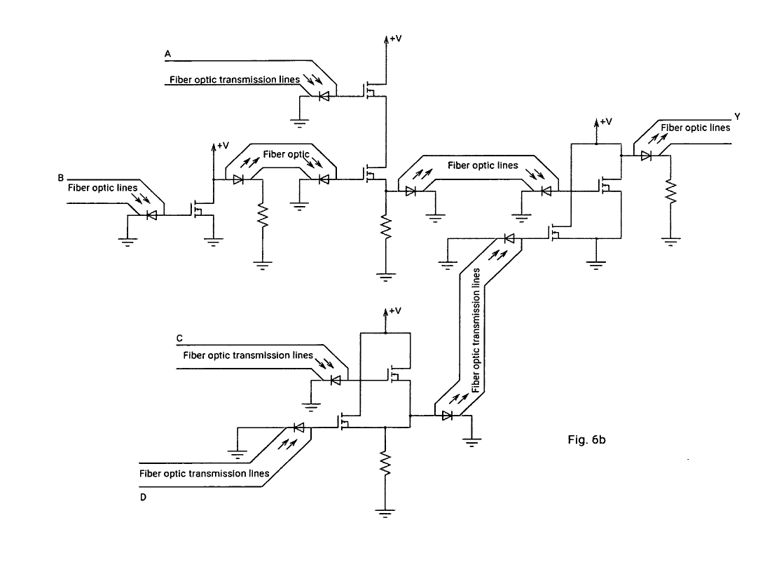

The schematic symbols in FIG. 1, FIG. 2, FIG. 3, FIG. 4, FIG. 5, and FIG. 6 are like a short hand that is used to describe know functions of certain circuits. Instead of drawing the complete circuits the industry uses these symbols to describe a particular function on a schematic.

FIG. 1b and FIG. 1c are NOT gates (inverters) and consist of just one transistor from ground to power. The microscopic output LED's anode has to be connected to the collector of the BJT or drain of the FET. Because the cathode faces ground and the anode is connected to the positive voltage source the output LED will remain on until another path of least resistance opens up. For this reason, a resistor; is placed in series with the output diode. This means that the output LED will always conduct except when the transistor is in saturation mode. With the transistor in saturation mode current will bypass the output LED and flow from ground to the positive voltage source through the transistor. When the transistor is in saturation mode the LED will be off, and when the transistor is in cutoff mode the LED will be on. This would prove the truth table in FIG. 1a for the inverter circuit correct in that every logical high input would be inverted into a logical low and vice versa.

FIG. 2b and FIG. 2c are AND gates and are made of two or more transistors connected in series from ground to the power source. The operation of a circuit for this Logic gate would be the same except, if there is at least one transistor in the circuit in cutoff mode a logical low be would yielded and the output LED will not conduct. Both transistors have to be in saturation mode to yield a logical high and for the output LED to conduct. This would prove the truth table in FIG. 2a for the AND gate circuit correct in that all inputs need to be logical highs for one logical high to be yielded as an output.

FIG. 3b and FIG. 3c are OR gates and are made of two or more transistors connected in parallel to each other from ground to the power source. The operation for this Logic gate would be the same except that for this circuit any transistor in saturation mode would yield a logical high output and the LED will conduct. Only one transistor in saturation would be necessary to yield a high output and for the output LED to conduct. This arrangement would prove the truth table in FIG. 3a for an OR gate circuit correct in that any logical high input would yield a logical high output.

FIG. 4b and FIG. 4c are NAND gates and would be constructed the same way as an AND gate would be except the output LED would have to be connected to the collector of the BJT or the gate of the FET. The cathode of the output LED would be connected to a resistor and the resistor to ground. The anode of the LED would be connected to the voltage source. When all transistors in the circuit are in saturation mode current will flow through the transistors bypassing the output LED causing it not to conduct. When all transistors are in cutoff mode the LED will conduct. This would prove the truth table in FIG. 4a for a NAND gate circuit correct in that any logical low input would yield a logical high as an output.

FIG. 5b and FIG. 5c are NOR gates and would be constructed the same way as an OR gate would be except the output LED would be connected to the collector of the BJT or the gate of the FET. The cathode of the output LED would be connected to a resistor and the resistor to ground. The anode of the LED would be connected to the voltage source. Only one transistor in the circuit is needed to be in saturation mode to shunt current away from the output LED. When any of the transistors are in saturation mode current from ground to the voltage source through the transistors and will bypass the output LED. When all transistors are in cutoff mode the LED will conduct. This would prove the truth table in FIG. 5a for an NOR gate circuit correct in that any logical high input would yield a logical low output.

As seen in FIG. 6a and FIG. 6b the Logic gates themselves will be connected to each other by fiber-optic transmission lines enabling the design of faster, more efficient, and less error prone integrated circuits.

I claim:

1. A logic family design method comprising:
a) A photodiode attached to the base of the BJT transistor;
b) A photodiode attached to the gate of the FET;
c) An LED attached to the emitter of the BJT or the collector for the negation function
d) An LED attached to source of the FET or the drain for the negation function;
e) Fiber optic lines coming from the previous logic circuit connected to the photodiode and connected to the LED going to the next logic circuit.

2. A microscopic input photodiode as in claim 1 wherein the photodiode converts logical highs and lows in the form of light into equivalent electronic current pulses to be processed by the transistor.

3. A microscopic output LED as in claim 1 wherein the LED converts logical highs and lows in the form of electronic current pulses that have been processed by the transistor into light.

4. Fiber optic lines as in claim 1 wherein the fiber optic transmission lines transmit light signals from the output LED of one logic circuit to the input photodiode of the next logic circuit.

5. The microscopic output LED as in claim 1 wherein the LED acts as a relay turning on and off the logic circuit that it is associated with.
